(19) United States
(12) Patent Application Publication
(10) Pub. No.: US 2026/0312418 A1
(43) Pub. Date: Oct. 8, 2026

(54) CONTROL DEVICE FOR ELECTRIFIED VEHICLE

(71) Applicant: TOYOTA JIDOSHA KABUSHIKI KAISHA, Toyota-shi (JP)

(72) Inventor: Masanori KOASHI, Okazaki-shi (JP)

(73) Assignee: TOYOTA JIDOSHA KABUSHIKI KAISHA, Toyota-shi (JP)

(21) Appl. No.: 19/558,799

(22) Filed: Mar. 6, 2026

(30) Foreign Application Priority Data
Apr. 4, 2025 (JP) 2025-062305

(51) Int. Cl. H02J 7/68; B60L 53/16; B60L 53/60

(52) U.S. Cl. CPC H02J 7/68; B60L 53/16; B60L 53/60

(57) ABSTRACT

The control device is a control device for a AC that is connected to a battery, that is capable of both DC and AC charge, that is, a charging circuit in which a part of the power lines are shared between the charging circuit and DC charging circuit, and that is, a single inlet to which a charging connector of an external power source is removably attachable and that is connected to the charging circuit and that is shared between the charging circuit and DC charging. The control device stops AC charge control when it is determined that a voltage is applied to AC charging circuit and that there is no frequency of the voltage while executing AC charge control in a state where the charging connector is connected to the inlet.

### CROSS-REFERENCE TO RELATED APPLICATION

This application claims priority to Japanese Patent Application No. 2025-062305 filed on Apr. 4, 2025. The disclosure of the above-identified application, including the specification, drawings, and claims, is incorporated by reference herein in its entirety.

### BACKGROUND

### 1. Technical Field

The present disclosure relates to a control device for an electrified vehicle.

### 2. Description of Related Art

Japanese Patent No. 7524863 discloses an electrified vehicle including a battery, an inlet, a charging circuit, and a control device, in which external charging is performed using electric power supplied from an external power source.

### SUMMARY

As an electrified vehicle capable of external charging, there is known an electrified vehicle including a charging circuit and an inlet. The charging circuit is a charging circuit that is used as both an AC charging circuit and a DC charging circuit. The inlet is an inlet that is used as both an AC charging inlet and a DC charging inlet. However, in this electrified vehicle, when an energization path of the DC charging circuit is formed during the execution of AC charging, there is a possibility that electric power flows backward from the battery to the external power source by the DC charging circuit.

The present disclosure provides a control device for an electrified vehicle, the control device being capable of suppressing electric power flowing backward from the electrified vehicle to an external power source during the execution of AC charging.

An aspect of the present disclosure provides

a control device for an electrified vehicle, the control device including: a battery;

a charging circuit that is connected to the battery, enables both AC charging and DC charging, and includes a power line, a part of the power line being used for both an AC charging circuit and a DC charging circuit; and

a single inlet to which a charging connector of an external power source is removably attachable, and that is connected to the charging circuit and used for both the AC charging and the DC charging.

The control device stops AC charging control during execution of the AC charging control with the charging connector connected to the inlet when determination is made that a voltage is applied to the AC charging circuit and the voltage does not have a frequency.

According to the present disclosure, it is possible to suppress electric power from flowing backward from an electrified vehicle to an external power source during the execution of AC charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an electrified vehicle according to an embodiment;

FIG. 2 is a diagram for explaining a flow of electricity during AC charge;

FIG. 3 is a diagram for explaining how to confirm the status of a system; and

FIG. 4 is a flowchart illustrating a process flow of AC charge control.

### DETAILED DESCRIPTION OF EMBODIMENTS

Hereinafter, an electrified vehicle control device according to an embodiment of the present disclosure will be described in detail. The present disclosure is not limited to the embodiments described below.

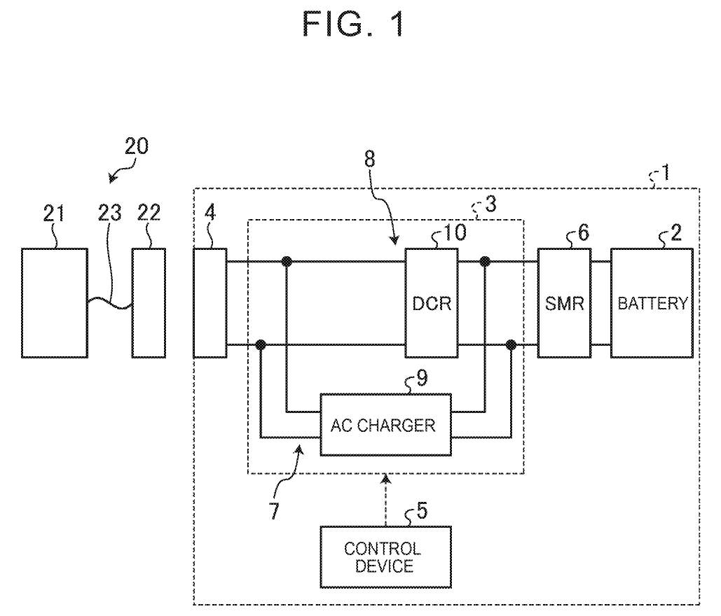

FIG. 1 is a diagram schematically illustrating an electrified vehicle according to an embodiment. Electrified vehicle 1 is an electrified vehicle that can be externally charged by electric power supplied from an external power source. Electrified vehicle 1 includes a battery 2, a charging circuit 3, an inlet 4, and a control device 5.

The battery 2 is a secondary battery that stores electric power to be supplied to the traveling motor. Battery 2 is a DC power supply mounted on an electrified vehicle 1. The battery 2 can be charged with electric power supplied from an external power source.

The charging circuit 3 is connected to the battery 2, converts electric power supplied from an external power source into electric power suitable for charging, and supplies the electric power to the battery 2. An SMR 6 is provided between the charging circuit 3 and the batteries 2. When SMR 6 is closed, the batteries 2 and the charging circuit 3 are electrically connected. When SMR 6 is open, the batteries 2 and the charging circuit 3 are electrically disconnected. SMR 6 is controlled by the control device 5.

The charging circuit 3 is capable of both AC charging and DC charging. The charging circuit 3 includes an AC charging circuit 7 and a DC charging circuit 8. In the charging circuit 3, some power lines are shared between AC charging circuit 7 and DC charging circuit 8. AC charging circuit 7 comprises an AC charger 9. AC charger 9 is a power converter that converts AC power supplied from an external power source into DC power and outputs the DC power to the batteries 2. AC charger 9 has an AC/DC converter that converts AC power supplied from the power system into power suitable for charging the batteries 2. DC charging circuit 8 has a DCR 10. DCR 10 is a charging relay that is controlled to be closed during external charging. DCR 10 is controlled by the control device 5.

The inlet 4 is connected to the charging circuit 3 and is a single charging inlet shared by both AC and DC charging. The inlet 4 is electrically connected to the batteries 2 via the charging circuit 3 and SMR 6. The inlet 4 is a common inlet that functions as an AC charge inlet and a DC charge inlet. An AC charging connector is detachable from the inlet 4, and a DC charging connector is detachable.

A charging connector 22 provided in the charging station 21 is attachable to and detachable from the inlet 4. The charging station 21 is installed in the power supply facility 20 and is connected to an external power source. The charging connector 22 is connected to the charging station 21 via a cable 23. The charging station 21 includes an AC charging station and a DC charging station. The charging connector 22 includes an AC charging connector and a DC charging connector. AC charging connector is connected to AC charge station via a cable 23. DC charging connector is connected to DC charge station via a cable 23. AC charging station and AC charging connector are included in a power system that supplies AC power. DC charging station and DC charging connector are included in a power system that supplies DC power.

The control device 5 is an electronic control device that controls the power supply device and the charging device. The power supply device includes a battery 2 and a SMR 6. The charging device includes a charging circuit 3 and an inlet 4. The control device 5 executes charging control for controlling the charging circuit 3 when external charging is performed. The control device 5 executes charge control, outputs a command signal to SMR 6, and controls SMR 6 to be closed. During the charge control, SMR 6 is closed, and the batteries 2 and the charging circuit 3 are electrically connected to each other. The charge control includes AC charge control and DC charge control.

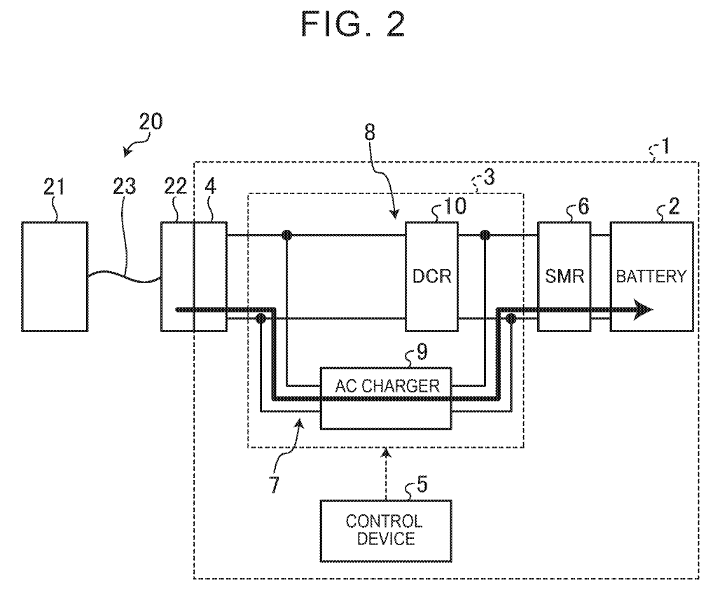

As shown in FIG. 2, AC charge control is charge control in which AC power supplied from an external power source via the inlet 4 is converted into DC power by AC charging circuit 7 and then supplied to the batteries 2. DC charge control is charge control for supplying DC power supplied from an external power source via the inlet 4 to the batteries 2 from DC charging circuit 8.

In electrified vehicle 1 configured as described above, the power lines of AC charging circuit 7 and the power lines of DC charging circuit 8 are partly shared in the charging circuit 3. Therefore, when the energization path of DC charging circuit 8 is erroneously formed during AC charge, the voltage of the power system becomes smaller than the voltage of the battery 2, so that the power of the battery 2 flows back to the power system. Therefore, the control device 5 is configured to correctly detect that AC is being charged, so that the energization path of DC charging circuit 8 is not formed during AC charge.

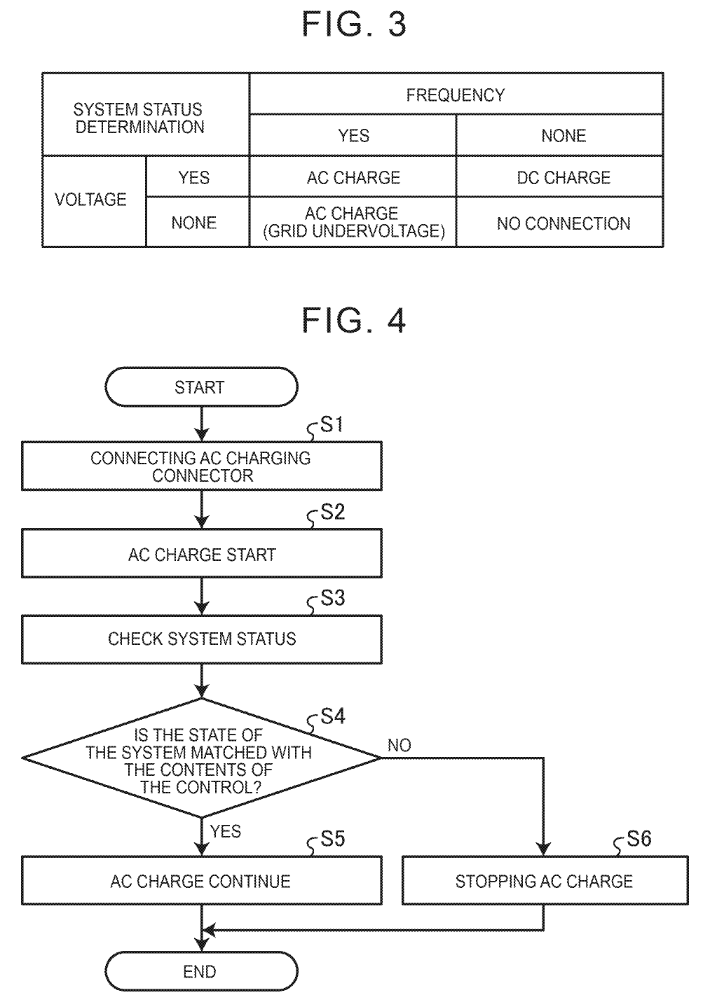

The control device 5 executes a process of checking the state of the system connected to the inlet 4. The control device 5 checks the status of the system by using a voltage sensor provided in AC charger 9. The voltage sensor detects a voltage applied to AC charger 9. The voltage sensor outputs a signal related to the detected voltage to the control device 5. As illustrated in FIG. 3, the control device 5 determines the state of the voltage and the presence or absence of the frequency based on the signal input from the voltage sensor, and determines the state of the system.

As shown in FIG. 3, when checking the state of the voltage, the control device 5 determines whether or not the voltage is equal to or greater than a predetermined value. When the voltage is equal to or higher than the predetermined value, it is determined that there is a voltage. When the voltage is less than the predetermined value, it is determined that there is no voltage. Without this voltage, there is a case where the voltage is a low voltage less than a predetermined value.

In addition, the control device 5 determines the presence or absence of the frequency of the voltage when checking the presence or absence of the frequency. When the frequency of the voltage is detected, the control device 5 determines that there is a frequency. When the frequency of the voltage cannot be detected, the control device 5 determines that there is no frequency.

When the control device 5 determines that there is a voltage and a frequency, it determines that the state of the system is a system of AC power, that is, an AC charge. When the control device 5 determines that there is a voltage and no frequency, it determines that the state of the system is a system of DC power, that is, a DC charge. When the control device 5 determines that there is no voltage and there is a frequency, it determines that the state of the system is a system of AC power, that is, an AC charge, and the voltage of the power system is a low voltage. When the control device 5 determines that there is no voltage and no frequency, it determines that there is no connection of the charging connector 22 to the inlet 4.

Then, the control device 5 compares the state of the system obtained by the determination result with the state of charge recognized by the control device 5. When the system state and the charging state coincide with each other, the control device 5 continues the charging. When the state of the system and the state of charge do not coincide with each other, there is a possibility that a reverse flow of electric power is generated from the battery 2 to the external power source side, and thus the control device 5 terminates the charging.

FIG. 4 is a flowchart illustrating a process flow of AC charge control. The control illustrated in FIG. 4 is performed by the control device 5.

The control device 5 detects that AC charging connector is connected to the inlet 4 (S1). In S1, an AC charging connector is connected to the inlet 4. The control device 5 detects the connection of AC charging connector on the basis of a signal or the like outputted from the inlet 4.

The control device 5 executes AC charge control (S2). In S2, AC charge is started.

The control device 5 checks the status of the system during AC charge (S3). In S3, the system status is determined as shown in FIG. 3. While executing AC charge control, the control device 5 determines whether or not a voltage is applied to AC charger 9 on the basis of a signal inputted from the voltage sensor of AC charger 9, and determines whether or not there is a frequency of the voltage.

The control device 5 determines whether or not the status of the system matches the content of the control (S4). In S4, it is determined whether or not the system status confirmed by S3 process matches AC charge control being executed by the control device 5. That is, in S4, it is determined whether or not the system status confirmed by S3 corresponds to AC charge.

When it is determined that the system status and the content of the control coincide with each other (S4: Yes), the control device 5 continues AC charge control (S5). AC charge is then continued. When S5 process is performed, the control routine ends.

When it is determined that the system status and the content of the control do not coincide with each other (S4: No), the control device 5 ends AC charge control (S6). AC charge is then deactivated. When S6 process is performed, the control routine ends.

As described above, according to the embodiment, the control device 5 can correctly detect that AC is being charged, so that the energization path of DC charging circuit 8 is not formed during AC charge. Accordingly, it is possible to suppress the electric power of the batteries 2 flowing back to the electric power system during AC charge.

Note that the control device 5 may acquire data from other ECU as needed, and improve the accuracy of the determination of the system status. For example, the control device 5 mounted on electrified vehicle 1 may consider charge determination in a HLC-ECU where communication with the charging station 21 is performed when determining the status of the system.

What is claimed is:

1. A control device for an electrified vehicle, the control device comprising:
a battery;
a charging circuit that is connected to the battery, enables both AC charging and DC charging, and includes a power line, a part of the power line being used for both an AC charging circuit and a DC charging circuit; and
a single inlet to which a charging connector of an external power source is removably attachable, and that is connected to the charging circuit and used for both the AC charging and the DC charging, wherein
the control device stops AC charging control during execution of the AC charging control with the charging connector connected to the inlet when determination is made that a voltage is applied to the AC charging circuit and the voltage does not have a frequency.

2. The control device according to claim 1, wherein:
the AC charging circuit includes an AC charger provided with a voltage sensor; and
determination is made whether a voltage is applied to the AC charger and whether the voltage has a frequency based on a signal input from the voltage sensor during the execution of the AC charging control.

3. The control device according to claim 1, wherein the DC charging circuit is electrically connected to the charging connector and electrically connected to the battery during execution of the AC charging.
